(19) United States
(12) Patent Application Publication
(10) Pub. No.: US 2021/0401198 A1
(43) Pub. Date: Dec. 30, 2021

(54) TABLE CLOTH HAVING DRAWSTRING HANDLES

(71) Applicant: Alicia Allen, Lakeland, FL (US)

(72) Inventor: Alicia Allen, Lakeland, FL (US)

(21) Appl. No.: 16/236,342

(22) Filed: Dec. 29, 2018

(51) Int. Cl. A47G 11/00; B65F 1/00

(52) U.S. Cl. CPC A47G 11/004; B65F 1/002

(57) ABSTRACT

Disposable tablecloth having drawstring handles and optional cinching elements.

### TECHNICAL FIELD

Some implementations relate generally to tablecloths, and more particularly to decorative party tablecloths that cover and protect a table in a first mode and transform into a drawstring trash bag in a second mode when no longer needed as a tablecloth.

### BACKGROUND

Most parents have a birthday party for their child every year with all the matching decor. Set-up and clean-up can be time consuming, frustrating and messy.

There may be a need to have your tablecloth held down from wind. There may also be a need for a quick and convenient method to collect trash from a table and other areas after a party.

The disclosed subject matter came from having parties for my own children and being a party hostess for years.

### SUMMARY

Some implementations can include a tablecloth that is made of leak proof material (e.g., plastic, paper coated with plastic top or backing, etc.) and has drawstring handles and cinched edges (e.g., using a stretchy material such as elastic) for easy setup. Once the party is over, the handles can be pulled out from the edge of the tablecloth causing the tablecloth to gather and serve as a trash bag (e.g. for the disposable items on the table).

Some examples can include designs to match party decor while protecting the table and providing you with a quick, easy, leak proof clean up. The Drawstring tablecloth makes setup and cleanup a breeze while matching the party theme.

### BRIEF DESCRIPTION OF THE DRAWINGS

FIG. 1 is a diagram of how the handle will be accessible when you are ready to bag up the trash.

FIGS. 2A-2D are diagrams showing example standard shapes for the drawstring tablecloth.

FIGS. 3A-3D are diagrams showing how the handles will be placed in the edge of the material.

FIGS. 4A-4D are diagrams showing where the tablecloth will be cinched to be able to attach to the table easily without any extra material hanging down.

FIGS. 5A-5D are flow charts showing how to use the disclosed tablecloth.

### DETAILED DESCRIPTION

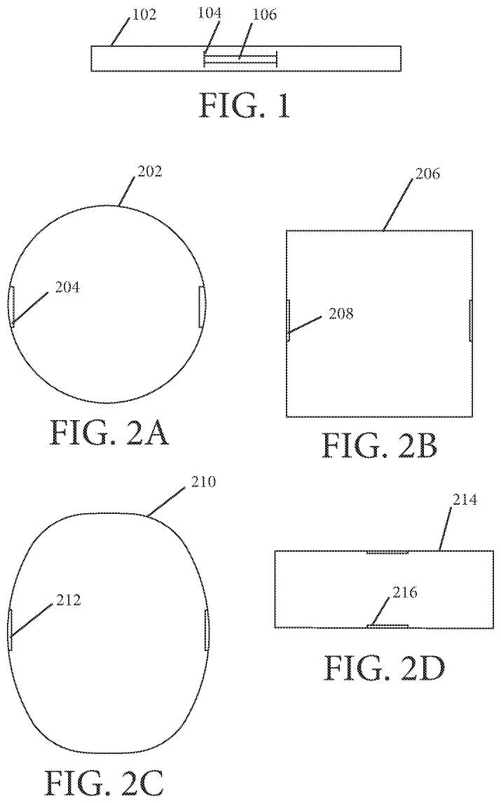

FIG. 1: This is showing a side view of the table while using the drawstring tablecloth 102. The spaces 104 where the handles 106 can be drawn are shown.

FIGS. 2A-2D show example standard shapes that the cinch cloth would cover and where the handles will be placed. FIG. 2A shows a round tablecloth 202 with handles 204. FIG. 2B shows a square tablecloth 206 with handles 208. FIG. 2C shows an oval tablecloth 210 with handles 212. FIG. 2D shows a rectangle tablecloth 214 with handles 216.

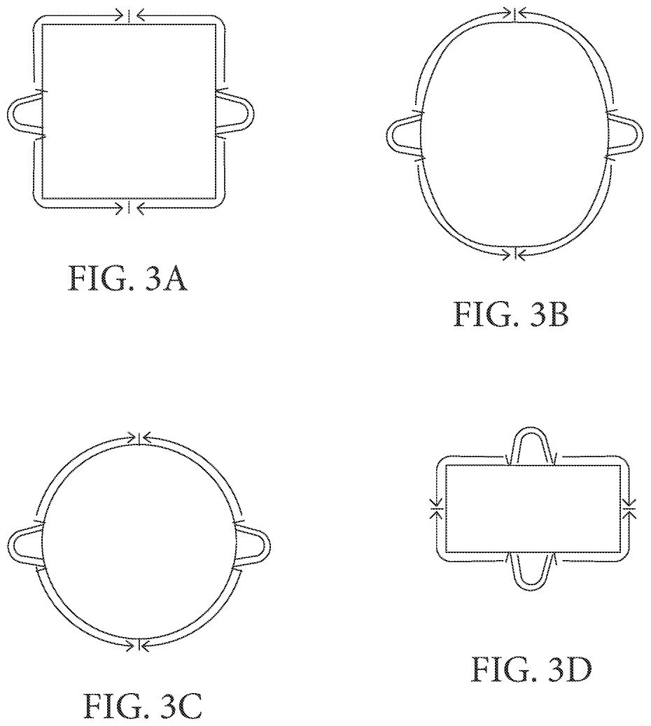

FIGS. 3A-3D: show where the handles are attached to the edge of the table cloth and how the handles come out. The arrows indicate where the handle material is passing, hidden from view, within a pocket formed by the table cloth.

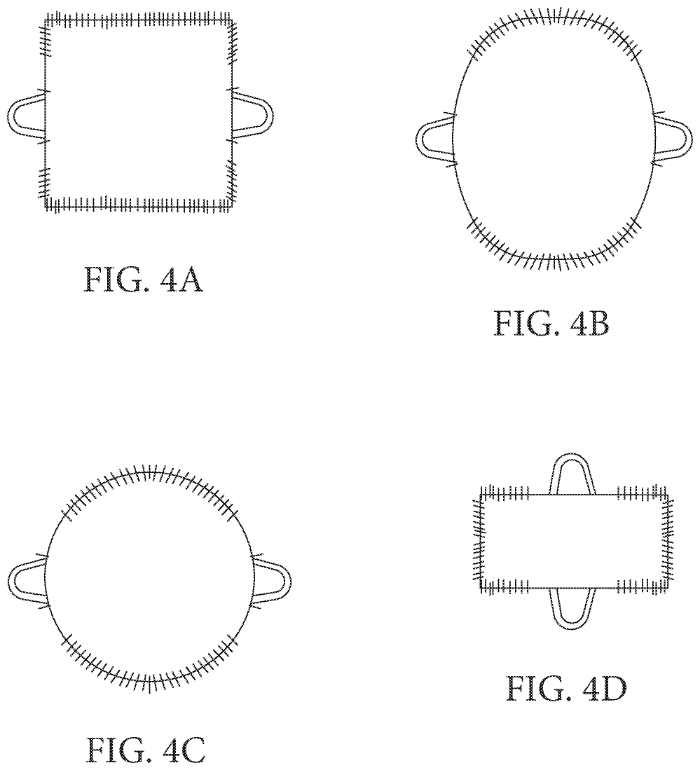

FIGS. 4A-4D: The tally marks are showing where the tablecloth material will be cinched so there will not be any extra material hanging down.

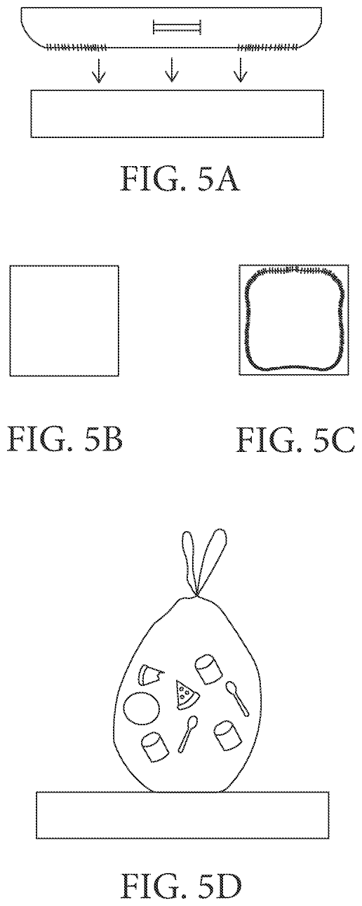

FIGS. 5A-5D: Flow Chart a) This diagram shows the cinched in edges that will go around the edge of the table. b/c) This is a top and bottom view of the table. The top with decoration and the bottom showing how the drawstring tablecloth attaches underneath the table. d) Shows the tablecloth having been removed and the drawstrings gathered, converting it into a trash bag ready for disposal.

The tablecloth can be made of flexible plastic material to prevent tears and leakage.

The cinching material can include stretchable edges (e.g., having elastic or other stretchy material) to ensure a snug fit around the edges of the table.

The drawstring handles can be constructed and arranged similar to the drawstring handles on conventional drawstring handle trash bags.

It is, therefore, apparent that there is provided, in accordance with the various embodiments disclosed herein, a tablecloth having drawstring handles.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A disposable tablecloth comprising:
a body portion having a top surface and a bottom surface;
an edge pocket formed adjacent to at least one edge of the body portion; and
a drawstring disposed within the edge pocket with the drawstring having a first end and a second end; wherein the first end and second end are attached to the edge pocket;
wherein the edge pocket has at least one opening that exposes the drawstring.

2. The disposable tablecloth of claim 1, further comprising a cinching member disposed along at least one edge.

3. The disposable tablecloth of claim 1, wherein the top surface includes an imprint of a design.
